(19) United States
(12) Patent Application Publication
(10) Pub. No.: US 2001/0009349 A1
(43) Pub. Date: Jul. 26, 2001

(54) Shadow mask assembly

(75) Inventors: Yoshito Tanaka, Shiga (JP); Akihiro Kamada, Shiga (JP); Hiroshi Hasegawa, Shiga (JP); Takashi Morohashi, Shiga (JP); Nobumitsu Aibara, Shiga (JP)

Correspondence Address: Patent Group, Hutchins, Wheeler & Dittmar, 101 Federal Street, Boston, MA, 02110, US

(73) Assignee: NEC Corporation

(21) Appl. No.: 09/765,481

(22) Filed: Jan. 18, 2001

(30) Foreign Application Priority Data
Jan. 20, 2000 (JP) 2000-14189

(51) Int. Cl. H01J 29/80

(52) U.S. Cl. 313/402; 313/407

(57) ABSTRACT

A shadow mask assembly includes a mask frame and a shadow mask supported by the mask frame for extension. The mask frame is of a rectangular shape having a pair of longer side members and a pair of shorter side members. Both the edges of the shadow mask is bonded onto the longer side members while the shorter side members are bent by an external force within the elasticity thereof. After the external force is removed, the shorter side members are slightly deformed within the elasticity thereof whereas the deformation of the longer side members is substantially removed. Suitable tension can be applied to the shadow mask in a wider temperature range.

### BACKGROUND OF THE INVENTION

(a) Field of the Invention

The present invention relates to a shadow mask assembly and, more particularly, to a shadow mask assembly including a shadow mask and a mask frame supporting thereon the shadow mask for extension.

(b) Description of the Related Art

A shadow mask assembly is generally used in a color cathode ray tube (CRT). FIG. 1 shows a first conventional shadow mask assembly, generally designated by numeral 110, which includes a frame 111, an aperture grill 112 mounted thereon and having a plurality of apertures 113 therein for passing electron beams, and a pair of damper wires 114 for fixing the aperture grill 112 onto the frame 111. In this text, the assembly 110, which is not called a “shadow mask assembly” in the market, is yet referred to as a shadow mask assembly for the purpose of convenience.

Each of the apertures 113 is formed as an elongate slit, which extends parallel to the other elongate slits separated from one another. This structure of the aperture grill 112 necessitates a higher tension to be exerted by the frame 111 for fixing the apertures 113 at respective normal positions. The higher tension requires a higher mechanical strength for the frame 111 and thus increases the weight of the shadow mask assembly 110. In addition, the damper wires 114 disposed for preventing or damping vibration of the aperture grill 112 project the shadow thereof onto the screen, and degrades the image quality formed by the shadow mask assembly 110.

FIG. 2 shows a second conventional shadow mask assembly, generally designated by numeral 120, which includes a mask frame 121 and a shadow mask 122 mounted thereon. The shadow mask 122 is made of an alloy having a low coefficient of thermal expansion, such as Invar. Although the shadow mask 122 covers the entire front side of the rectangular mask frame 121, the shadow mask 122 illustrated in the figure is represented by the contour line thereof for depicting the structure of the mask frame 121.

If the mask frame 121 is made of an expensive metal or alloy having a low coefficient of thermal expansion, such as Invar, similarly to the shadow mask 122, the cost for the shadow mask assembly 120 is increased. More specifically, the mask frame 121 has a larger volume compared to the shadow mask 122, and thus the mask frame 121 made of Invar is extremely expensive to thereby raise the total cost of the shadow mask assembly.

### SUMMARY OF THE INVENTION

In view of the above problems in the conventional techniques, it is an object of the present invention to provide a low-cost shadow mask assembly with light weight and substantially without causing plastic deformation of the shadow mask.

The present invention provides a shadow mask assembly including a mask frame having a substantially rectangular shape including a pair of first side members and a pair of second side members bonded onto the first side members to form the substantially rectangular shape, and a shadow mask having a pair of edges bonded onto edges of the respective first side members, the second side members being elastically deformed to extend the shadow mask within an elastic limit of the shadow mask.

In accordance with the present invention, the elastic deformation of the second side members allows the mask frame to afford a suitable tension to the shadow mask in a wide temperature range. The suitable tension exerted between the shadow mask and the second side members prevents a plastic deformation of the shadow mask, whereby the shadow mask assembly provides an excellent image quality.

The above and other objects, features and advantages of the present invention will be more apparent from the following description, referring to the accompanying drawings.

### BRIEF DESCRIPTION OF THE DRAWINGS

FIG. 1 is a perspective view of a first conventional shadow mask assembly.

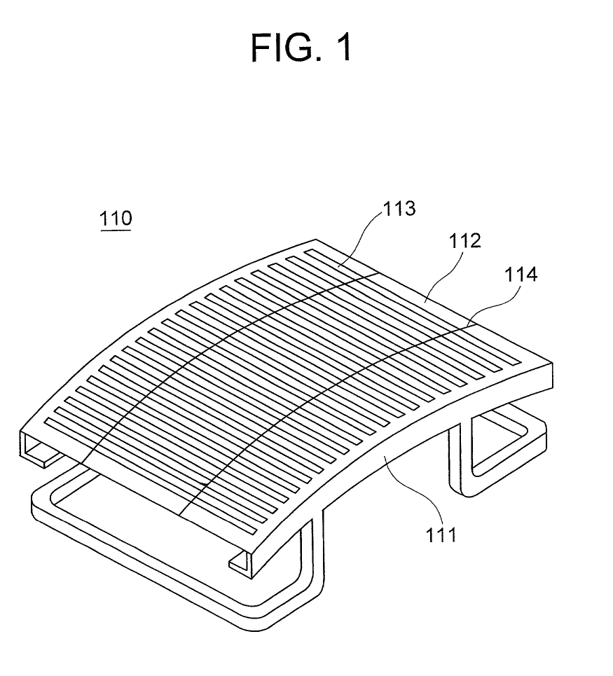

FIG. 2 is a perspective view of a second conventional shadow mask assembly.

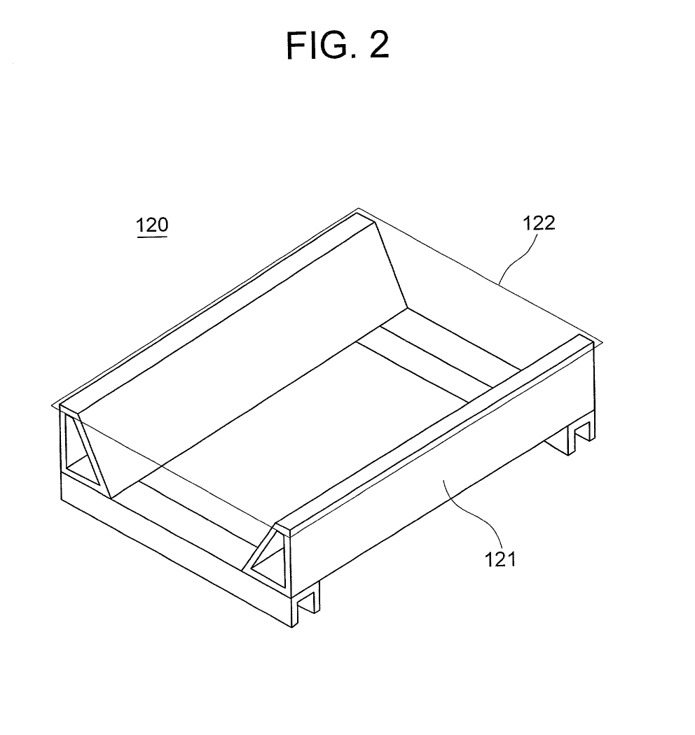

FIG. 3 is a perspective view of a shadow mask assembly according to a first embodiment of the present invention.

FIG. 4 shows a top plan view and a side view of the mask frame shown in FIG. 3.

FIG. 5 shows a top plan view and a side view of the mask frame of FIG. 4 when it is applied with an external force before extending thereon the shadow mask.

FIG. 6 shows a top plan view and a side view of the shadow mask assembly of FIG. 3 after the shadow mask is extended on the mask frame applied with the external force.

FIG. 7 is a perspective view of a shadow mask assembly according to a second embodiment of the present invention.

FIG. 8 is a perspective view of a shadow mask assembly according to a third embodiment of the present invention.

FIG. 9 shows a top plan view and a side view of the mask frame shown in FIG. 8.

FIG. 10 shows a top plan view and a side view of the mask frame of FIG. 9 when it is applied with an external force before extending thereon the shadow mask.

FIG. 11 shows a top plan view and a side view of the shadow mask assembly of FIG. 8 after the shadow mask is extended on the mask frame applied with the external force.

FIG. 12 is a perspective view of a shadow mask assembly according to a fourth embodiment of the present invention.

### PREFERRED EMBODIMENTS OF THE INVENTION

Now, the present invention is more specifically described with reference to accompanying drawings, wherein similar constituent elements are designated by related reference numerals for the sake of understanding.

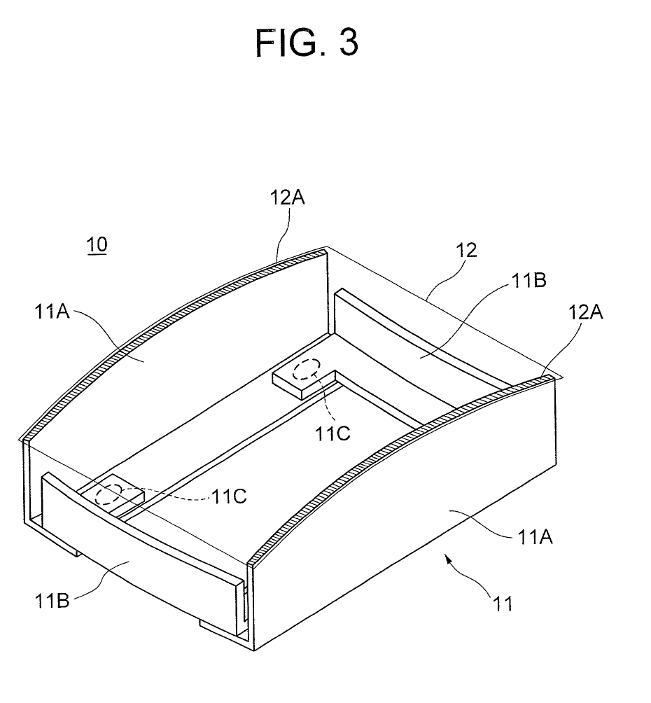

Referring to FIG. 3, a shadow mask assembly, generally designated by numeral 10, according to a first embodiment of the present invention includes a mask frame 11 and a shadow mask 12 mounted thereon at the front side thereof. The shadow mask 12 is shown by the contour line thereof. The shadow mask assembly 10 of FIG. 3 is used for a color CRT having a 19-inch diagonal size, for example.

The mask frame 11 is of a rectangular shape, as viewed from the front, and includes a pair of longer side members 11A and a pair of shorter side members 11B. The longer side member 11A is substantially straight and has a larger depth as viewed from the side of the shadow mask assembly 10 compared to the shorter side member 11B. The shorter side member 11B has a substantially straight portion, with a pair of transverse extensions formed at both the ends of the straight portion. The longer side member 11A is made of 13-chrome stainless steel having an L-shape in cross-section, including a pair of flanges each having a thickness of 2.5 mm. The shorter side member 11B is made of 13-chrome stainless steel having an L-shape in cross-section, including a pair of flanges each having a thickness of 2.2 mm.

Each of the end portions of the longer side member 11A and a corresponding transverse extension of the shorter side member 11B are bonded together by welding at the bonding part 11C. More specifically, the transverse extension extending from one of the flanges of the shorter side member 11B extending substantially parallel to the shadow mask 12 is disposed on the inner surface of the corresponding flange of the longer side member 11B at the bonding part 11C.

The shorter side member 11B is more liable to deformation compared to the longer side member 11A due to the difference in the thickness between the shorter side member 11B and the longer side member 11A. The shadow mask 12 is made of Invar having a thickness of 0.1 mm and extended on the front side of the mask frame 11. Both the edges 12A of the shadow mask 12 are bonded onto the edges one of the flanges of the respective longer side members 11A.

The mask frame 11 extends or stretches the shadow mask 12 within the elastic limit of the shadow mask 12 in the extending direction of the shorter side members 11B, due to the remaining elastic deformation of the shorter side members 11B. Since the shorter side members 11B can sufficiently extend within the elastic limit of the shadow mask, a higher temperature during the fabrication of a color CRT by using the shadow mask assembly 10 does not cause a plastic deformation of the shadow mask 12.

The side members 11A and 11B of the mask frame 11 may be made of another material instead, such as chrome molybdenum steel having the same thicknesses as recited above.

For example, the shadow mask assembly 10 has a longer side of about 360 mm, a shorter side of about 270 mm and a height (depth) of about 43 mm.

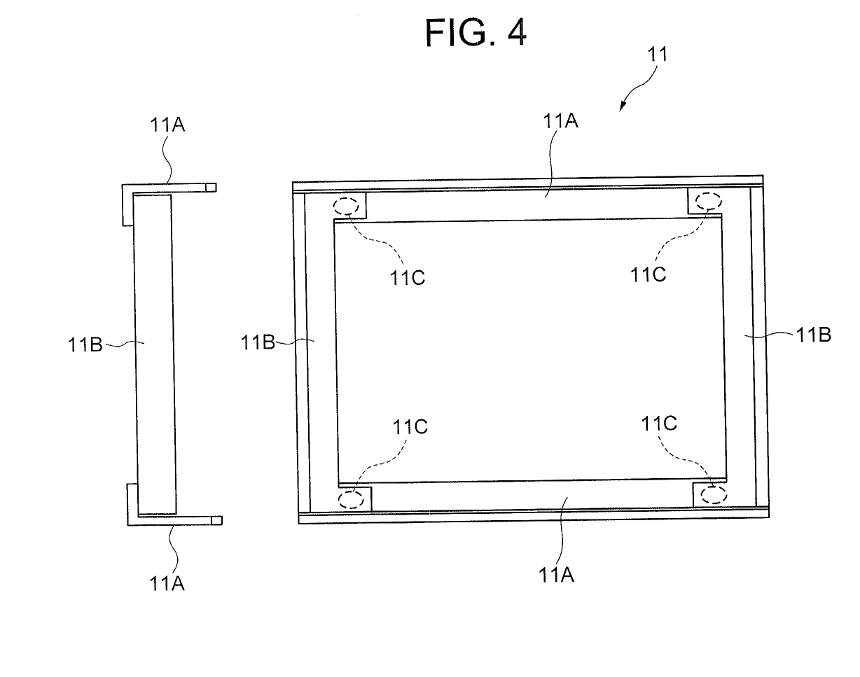

Referring to FIG. 4, the mask frame 11 is substantially of a hexahedron before the mask frame 11 is applied with an external force. The longer side members 11A and the shorter side members 11B are bonded together at the bonding part or bonding spot 11C by welding, brazing, rivets or screws to form the rectangular shape of the mask frame 11.

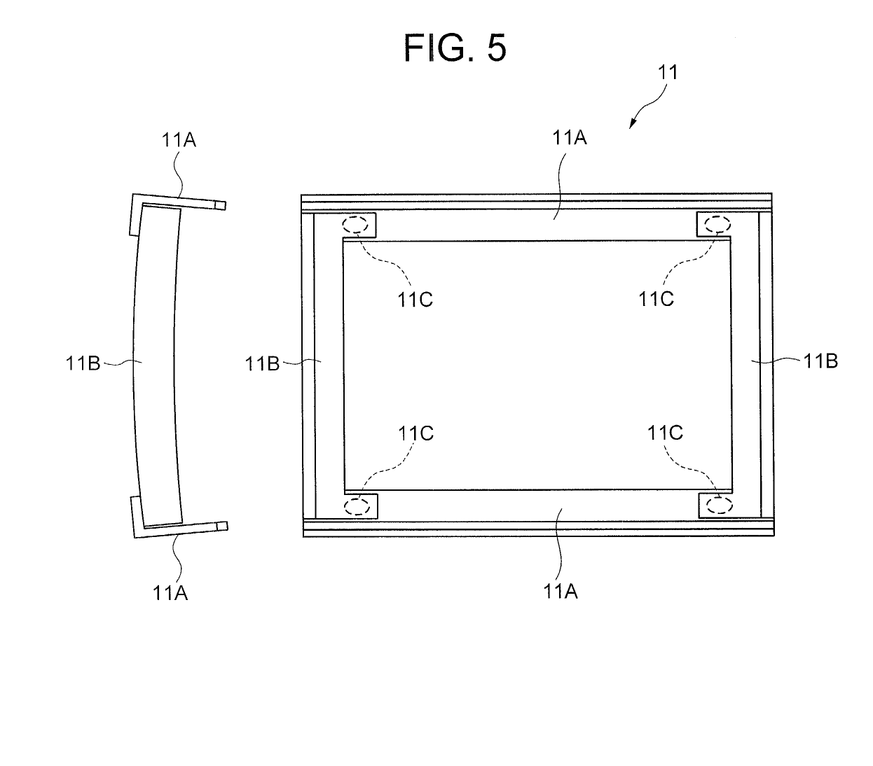

Referring to FIG. 5, the mask frame 11 is subjected to an external bending force applied to the shorter side members 11B before fixing the shadow mask 12 onto the mask frame 11. The external force deforms each of the shorter side members 11B, with both the ends thereof being raised with respect to the center thereof. Each of the longer side members 11A is also subjected to deformation in the direction normal to the extending direction of the longer side member 11A so that the angle between both the flanges of the L-shape is slightly reduced from 90 degrees. The amount of deformation of the shorter side members 11B can be controlled in a wide range by selecting the cross-sectional shape of the shorter side members 11B, the thickness of the flanges thereof, and the dimensions or position of the bonding part 11C.

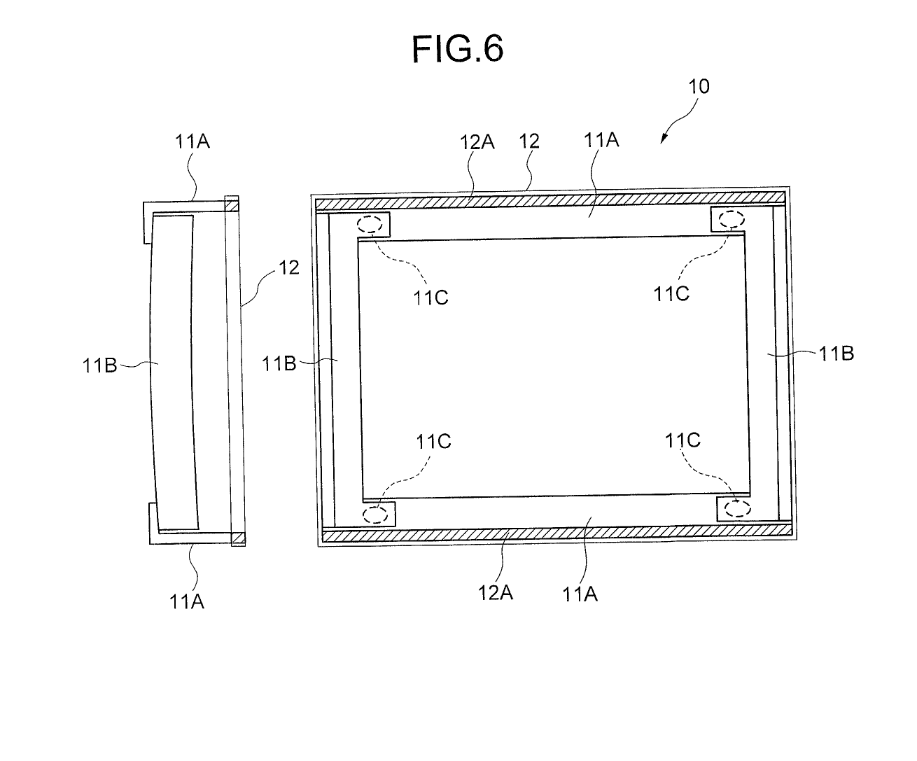

Referring to FIG. 6, the shadow mask 12 is extended or stretched on the mask frame 11 after welding both the edges 12A of the shadow mask 12 onto the front edges of the longer side members 11A with the external bending force being applied to the shorter side members 11B. As understood from FIG. 6, a remaining small deformation is left on the shorter side members 11B for extension of the shadow mask 12 after the removal of the external force. The angle between the flanges of each of the longer side members 11A returns to substantially 90 degrees after the removal of the external force. These deformations are within the elastic function of the side members 11A and 11B, and thus these side members are substantially free from plastic deformation, with slight elastic deformation left on the shorter side members 11B.

In the conventional shadow mask assemblies, the tension for the shadow mask or grill is applied mainly by the elasticity of the shorter side members 11B. On the other hand, the tension for the shadow mask 12 in the present embodiment is applied by the elasticity of the longer side members 11A in the direction normal to the extending direction of the longer side members 11A and the elasticity of the shorter side members 11B in the extending direction thereof. This widens the design choice in the structure for exertion of the tension to the shadow mask in the shadow mask assembly.

In addition, the remaining deformation (flexure) of the shorter side members 11B within the elasticity thereof assists the extension of the corners of the shadow mask 12, at which the shadow mask 12 is more liable to an insufficient tension compared to the other portions thereof.

The extension or stretch of the shadow mask 12 is generally conducted at a temperature of about 25° C. Thus, if a color CRT having a conventional shadow mask assembly is operated at a lower temperature of 5° C., for example, there may be an insufficient tension for the shadow mask, especially at the start of the operation of the color CRT. The insufficient tension causes deviation of the apertures to be passed by the electron beams and degrades the color purity of the image formed by the color CRT. The reason is that the coefficient of thermal expansion of the shadow mask is about one-tenth of that of the mask frame, and thus the mask frame contracts ten times more than the shadow mask at the lower temperature. The coefficient of thermal expansion of Invar is about 1.2 ppm at a room temperature.

On the other hand, in the shadow mask assembly 10 of the present embodiment, the shorter side member 11B has a sufficient elasticity at a temperature of 5° C. due to the slight deformation of the shorter side member 11B, resulting in a sufficient tension applied for the shadow mask 12.

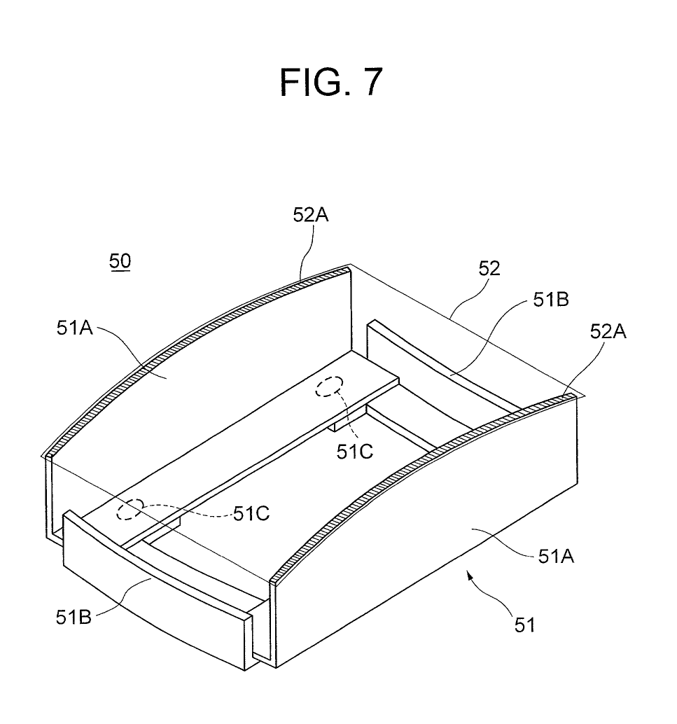

Referring to FIG. 7, a shadow mask assembly, generally designated by numeral 50, according to a second embodiment of the present invention is similar to the first embodiment except that the transverse extension extending from the flange of the shorter side member 51B substantially parallel to the shadow mask 52 is bonded onto the outer surface of the corresponding flange of the longer side member 51A at the bonding part 51C. The function of the second embodiment is similar to the first embodiment. The structure for the bonding part 11C or 51C may be selected depending on the feasibility of the bonding itself.

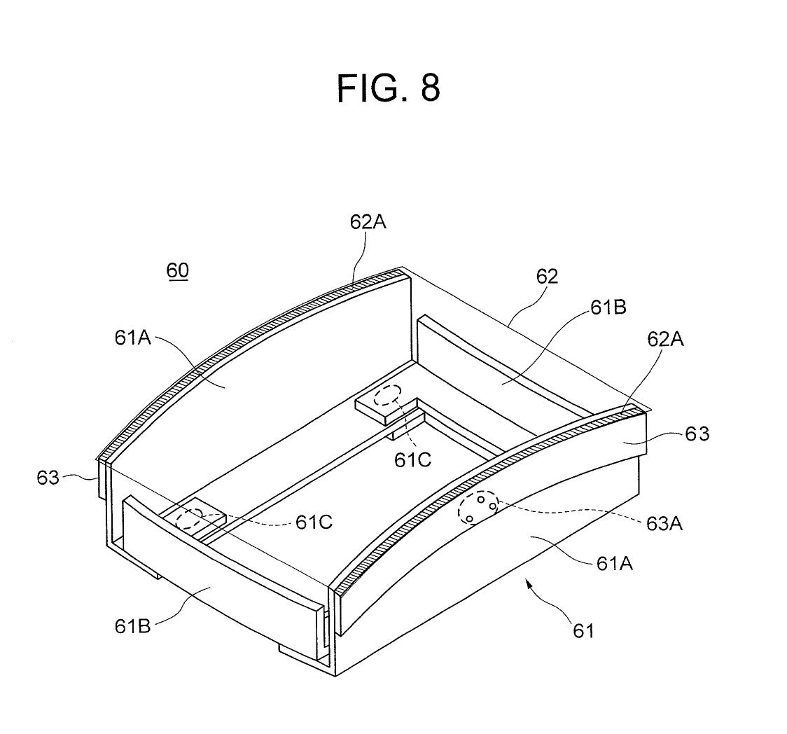

Referring to FIG. 8, a shadow mask assembly according to a third embodiment of the present invention is substantially similar to the first embodiment except for a pair of support plates 63 provided in the present embodiment. The support plate 63 extends along and is fixed onto the longer side member 61A of the mask frame 61 for fixing thereon the shadow mask 62. The support plate 63 is bonded onto the outer side surface of the longer side member 61 at bonding spots 63A. Both the edges 62A of the shadow mask 62 are bonded onto the front edges of the respective support plates 63.

The longer side member 61A of the mask frame 61 is made of 13-chrome stainless steel having an L-shape in cross-section and a thickness of 2.2 mm, whereas the shorter side member 61B is made of 13-chrome stainless steel having an L-shape in cross-section and a thickness of 2.0 mm. The shadow mask 62 is made of Invar having a thickness of 0.1 mm, and the support plate 63 is also made of Invar having a thickness of 3 mm. The shorter side member 61B is more liable to deformation compared to the longer side member 61A due to the difference in the thickness. Since the shorter side member 61B can deform within the elastic limit of the shadow mask 62, a higher temperature applied to the shadow mask assembly 60 during fabrication of a color CRT does not cause a plastic deformation of the shadow mask 62. The mask frame 61 may be made of chrome molybdenum steel instead of 13-chrome stainless steel. The overall dimensions of the shadow mask assembly of the present embodiment is similar to those of the first embodiment.

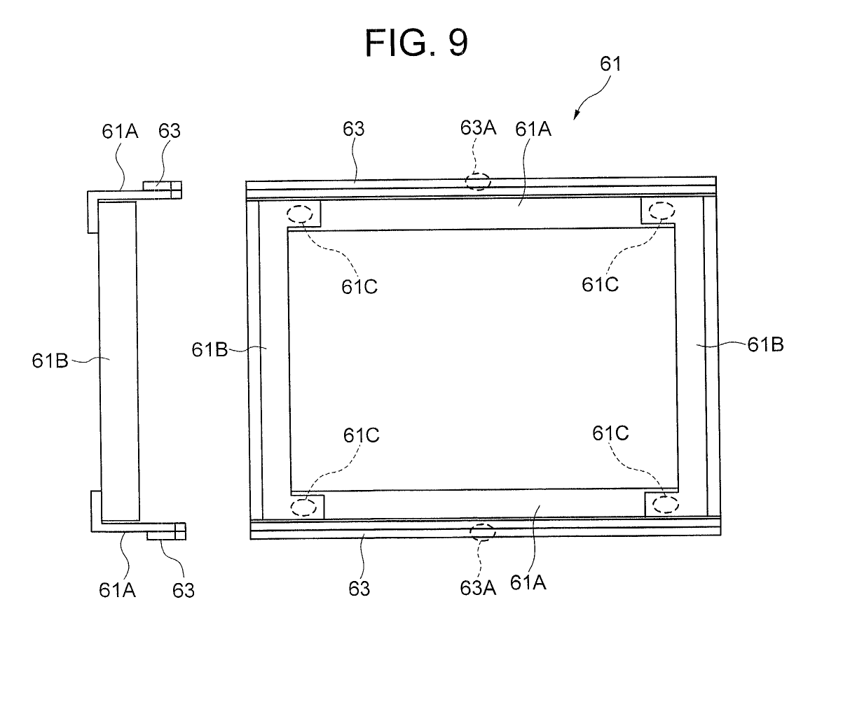

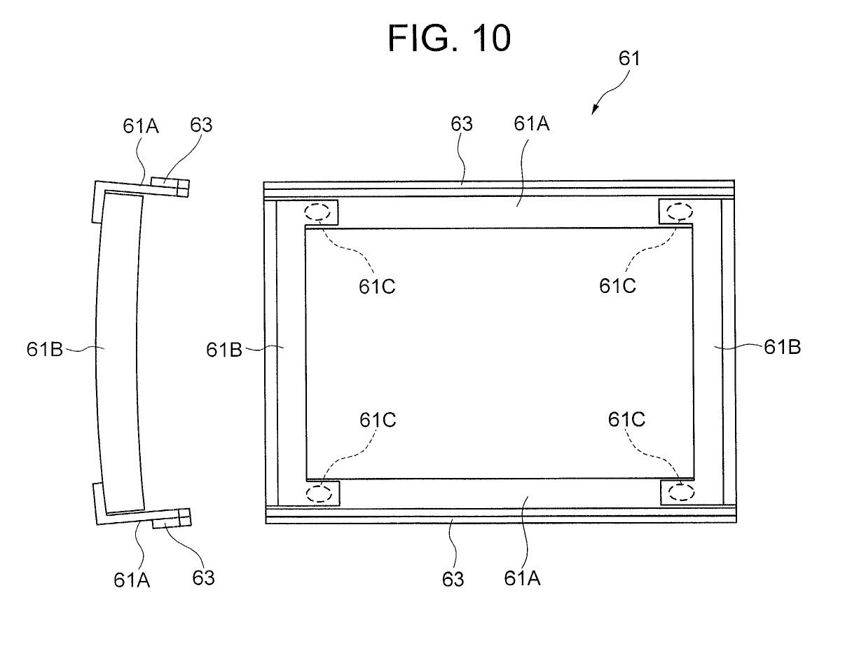

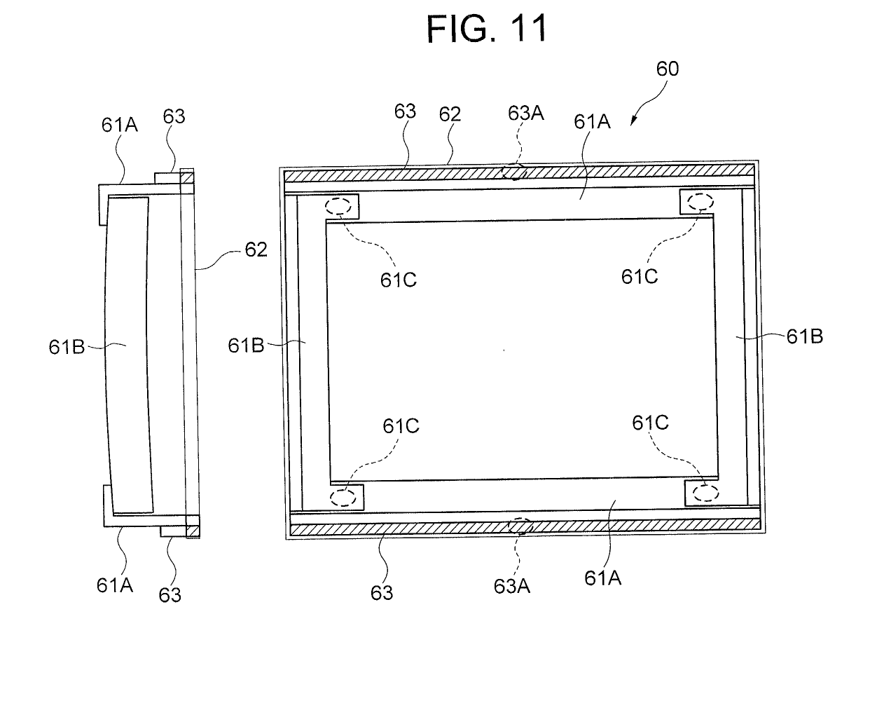

Referring to FIGS. 9 to 11, there is shown the function of the shadow mask assembly 60 of the present embodiment, which is similar to that described in connection with the function of the shadow mask assembly 10 of the first embodiment with reference to FIGS. 4 to 6.

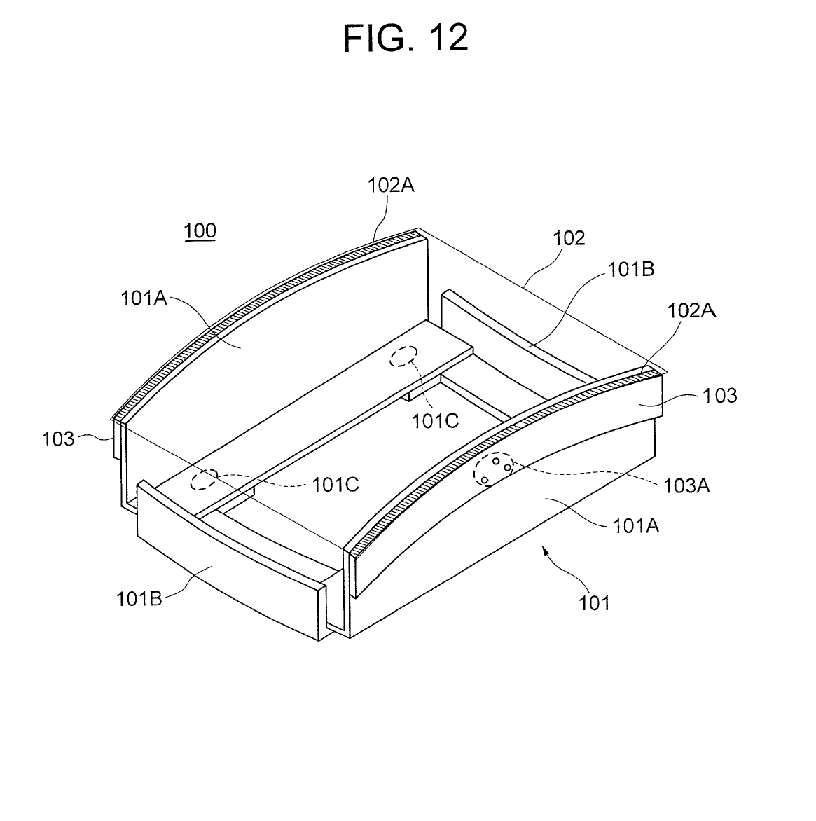

Referring to FIG. 12, a shadow mask assembly, generally designated by numeral 100, according to a fourth embodiment of the present invention is similar to the second embodiment except for a support plate 103 fixed onto the longer side member 101A of the mask frame 101 for fixing thereon the shadow mask 102. In other words, the shadow mask assembly of FIG. 12 is similar to the first embodiment except for the structure of the bonding of the shorter side member 101B onto the longer side member 11A. The structure and the material of the support plate 103 are similar to those of the support plate 63 shown in FIG. 8.

The support plate 63A or 103A has a front edge onto which the edge (edge portion) of the shadow mask 62 or 102 is bonded. Since the support plate 63A or 103A has a lower coefficient of thermal expansion, which is similar to that of the shadow mask 62 or 102, the shadow mask 62 or 102 is substantially free from deformation caused by thermal expansion. On the other hand, the shadow mask 12 or 52 in the first or second embodiment has a tendency of deformation caused by thermal expansion if the shadow mask assembly is subjected to a temperature of about 100° C. or above.

In the third and fourth embodiments, the discrepancy in the coefficient of thermal expansion between the support plate 63 or 103 and the longer side member 61A or 101A does not cause a warp due to the substantially single bonding part 63A or 103A between the support plate 63 or 103 and the longer side member 61A or 101A.

By employing the structures as described above, the shadow mask assembly according to the present invention has a light weight, can be manufactured at a low cost and is substantially free from plastic deformation of the shadow mask. In addition, the shadow mask is subjected to a suitable tension at a lower temperature range.

Since the above embodiments are described only for examples, the present invention is not limited to the above embodiments and various modifications or alterations can be easily made therefrom by those skilled in the art without departing from the scope of the present invention.

What is claimed is:

1. A shadow mask assembly comprising a mask frame having a substantially rectangular shape including a pair of first side members and a pair of second side members bonded onto said first side members to form said substantially rectangular shape, and a shadow mask having a pair of edges bonded onto edges of respective said first side members, said second side members being elastically deformed to extend said shadow mask within an elastic limit of said shadow mask.

2. The shadow mask assembly as defined in claim 1, wherein each of said first and second side members is of an L-shape having a pair of flanges.

3. The shadow mask assembly as defined in claim 2, wherein said flanges of said second side members are smaller in dimensions compared to said flanges of said first side members.

4. The shadow mask assembly as defined in claim 1, wherein said shadow mask is made of Invar, and said first and second side members are made of 13-chrome stainless steel or chrome molybdenum steel.

5. A shadow mask assembly comprising a mask frame having a substantially rectangular shape including a pair of first side members and a pair of second side members bonded onto said first side members to form said substantially rectangular shape, a pair of support plates each extending along one of said first side members and attached thereto, and a shadow mask having a pair of edges bonded onto edges of respective said support plates, said second side members being elastically deformed to extend said shadow mask within an elastic limit of said shadow mask.

6. The shadow mask assembly as defined in claim 5, wherein each of said first and second side members is of an L-shape having a pair of flanges.

7. The shadow mask assembly as defined in claim 6, wherein said flanges of said second side members are smaller in dimensions compared to said flanges of said first side members.

8. The shadow mask assembly as defined in claim 5, wherein said shadow mask and said support plates are made of Invar, and said first and second side members are made of 13-chrome stainless steel or chrome molybdenum steel.

9. A method for fabricating the shadow mask assembly as defined in claim 1, comprising the consecutive steps of applying an external force to said mask frame to bend said shorter side members within an elastic limit thereof, bonding said edges of said shadow mask onto said longer side members, and removing said external force to thereby extend said shadow mask so that said shadow mask applies a tension in said short side members so as to allow said shorter side members to elastically bend.

10. A method for fabricating the shadow mask assembly as defined in claim 5, comprising the consecutive steps of applying an external force to said mask frame to bend said shorter side members within an elastic limit thereof, bonding said edges of said shadow mask onto said longer side members, and removing said external force to thereby extend said shadow mask so that said shadow mask applies a tension in said short side members so as to allow said shorter side members to elastically bend.
